(19) United States
(12) Patent Application Publication
(10) Pub. No.: US 2023/0090666 A1
(43) Pub. Date: Mar. 23, 2023

(54) Lid Assembly for Adjusting Internal Pressure and Container with Assembly

(71) Applicant: Ningbo Tianma Kitchenware CO., LTD, Ningbo (CN)

(72) Inventor: Jihui Ma, Ningbo (CN)

(21) Appl. No.: 17/511,590

(22) Filed: Oct. 27, 2021

(30) Foreign Application Priority Data
Sep. 22, 2021 (CN) 202122299226.4

(51) Int. Cl. B65D 81/20; B65D 85/72; B67D 1/04; B67D 1/12

(52) U.S. Cl. CPC B65D 81/2053; B65D 85/72; B67D 1/0406; B67D 1/1252

(57) ABSTRACT

The present disclosure provides a lid assembly for adjusting internal pressure and a container, including a lid main body. The lid main body is provided with a gas nozzle, a sliding plug cavity, a slider nut, an elastic component and an adjusting assembly. The gas nozzle is configured to mount a gas bottle. The adjusting assembly adjusts a movement distance of a sliding plug in the sliding plug cavity and controls a gas output of the gas nozzle so as to control the content and pressure of gas in the container provided with the lid assembly, and improve a drinking taste of a gas-containing drink in the container. The container for containing the gas-containing drink of the present disclosure can maintain a gas (carbon dioxide) content in the drink, improve the drinking taste, and can be adjusted according to requirements to produce different tastes, being adaptable to different users.

### CROSS REFERENCE TO RELATED APPLICATIONS

The present application claims the benefit of Chinese Patent Application No. 202122299226.4 filed on Sep. 22, 2021, the contents of which are incorporated herein by reference in their entirety.

### TECHNICAL FIELD

The present disclosure relates to carbonated drinks or beer containers, and particularly relates to a lid assembly for adjusting internal pressure and a container with the assembly.

### BACKGROUND

Beer and carbonated drinks are both gas-containing drinks. Carbonated drinks contain carbon dioxide, with appropriate amounts of sugar, citric acid, essence, food coloring, etc. If carbon dioxide of about 2-3 atmospheric pressures is sealed in sugar water, part of carbon dioxide gas will be dissolved in water, carbon dioxide will form carbonic acid in water, and carbonic acid gives people the feeling of a unique stimulating taste. Beer is an alcoholic beverage brewed through liquid gelatinization and saccharification, and then through liquid fermentation, which takes wheat malts and barley malts as main raw materials. Beer's alcohol content is low, contains carbon dioxide, various amino acids, vitamins, low molecular weight sugar, inorganic salts and various enzymes, wherein the low molecular weight sugar and amino acids are easily digested and absorbed, and generate a lot of heat energy in the body, so beer is called “liquid bread”. The Beer of 1 L can produce 3000+ KJ of calories which are equivalent to the calories produced by 3-5 eggs or 210 g bread. A light manual worker can get ⅓ of the required calories if he/she can drink beer of 1 L per day.

Both beer and carbonated drinks contain carbon dioxide. When the content of carbon dioxide in the drinks decreases, the taste of carbonated drinks or beer will become poor, which affects normal drinking.

The existing craft brewing and original beer is packed in large barrels, and then sub-packaged through containers for drinking. During the sub-packaging and storing, part of internal carbon dioxide will be discharged, which affects the drinking taste and reduces the user's drinking experience.

### SUMMARY

### Technical Problem to be Solved

The technical problem to be solved by the present disclosure is to provide a lid assembly for adjusting internal pressure and a container with the assembly, which are compact in structure and convenient to adjust, to ensure the taste of the drink in the container, and can be adjusted according to different needs to meet the taste of the drink in the container.

### Technical Solutions for Solving Problem

The present disclosure provides a lid assembly for adjusting internal pressure, which includes:

a lid main body, as a mounting carrier for mounting other components, provided with:

a gas nozzle 71, configured to be connected with a gas bottle 8;

a sliding plug cavity, arranged at a gas output end of the gas nozzle 71, a sliding plug body 53 is arranged in the sliding plug cavity in a sliding fit mode, capable of being close to or away from the gas nozzle 71 and touching an ejecting pin on the gas nozzle 71 to control output amount of the gas of gas bottle 8, a sealed first chamber is formed between the sliding plug body 53 and the gas output end of the gas nozzle 71, and a side wall of the first chamber is opened with a first gas outlet 623 to communicate with a storage tank chamber;

a slider nut 51, arranged in the lid main body in a sliding fit mode, a sliding direction of the slider nut 51 being parallel to a sliding direction of the sliding plug body 53;

an elastic component 52, arranged between the slider nut 51 and the sliding plug body 53 and enabling the slider nut 51 and the sliding plug body 53 to trend to move in opposite directions;

an adjusting assembly, including a driving part and a driven part which are meshed and linked with each other, a head of the driving part extending to outside of the lid main body as an input end, and the driven part being in threaded connection with the slider nut 51 and driving the slider nut 51 to move; and

a connecting portion, configured to be connected to a container.

Further, the driving part and the driven part are connected through conical teeth.

Further, the lid main body is provided with a pressure meter 21, and the pressure meter 21 communicates with the first chamber through a gas flow channel.

Further, the driving part includes a driving bevel gear 32 rotatably mounted on a side wall of the lid main body and a shifter lever 33 located outside the lid main body and rigidly connected with the driving bevel gear; and the driven part includes a screw 4 rotatably mounted inside the lid main body and a driven bevel gear 31 fixed on the screw 4 and meshed with the driving bevel gear 32, a rotation axis of the screw 4 vertically intersects with a rotation axis of the driving bevel gear 32, and a thread 43a is configured to a side wall of the screw 4 for connection with the slider nut 51 to drive the slider nut to move.

Further, an end portion of the screw 4 extends downward to form a plunger portion 431, and an end portion of the plunger portion 431 is provided with a central hole penetrating upward to outside of the screw and forms a gas flow channel 400; and a top center of the sliding plug body 53 is provided with a plunger hole 531 allowing the plunger portion 431 to be inserted in through a sliding fit mode, a sealing part is arranged between the plunger portion 431 and the plunger hole 531, and a bottom surface of the plunger hole 531 is provided with a first gas hole 530 for the communication between the gas flow channel 400 with the first chamber.

Further, the screw 4 includes a supporting portion 41, a screw portion 43 and the plunger portion 431 which are sequentially connected from top to bottom and coaxially arranged, a lower end side wall of the supporting portion 41 extends outwards in a radial direction and forms an annular protrusion 42, an upper end of the sliding plug cavity is provided with a second stepped surface 622 to touch the annular protrusion to achieve axial limiting, a root of the supporting portion 41 is provided with a driven bevel gear, and the lid main body is provided with a casing pipe 202 allowing the supporting portion 41 to be inserted in.

Further, the supporting portion 41 is sleeved with a sleeve 311 through a key 412, a lower end of the sleeve 311 is in contact with an upper surface of the annular protrusion, a conical surface is formed at a lower end side wall of the sleeve 311, the conical surface is provided with teeth 31a and forms the driven bevel gear, an end portion of the casing pipe 202 is in connect with an end portion of the sleeve 311 and axial limiting is achieved.

Further, the lid main body includes an upper lid 2 and a lower lid 6 which are fixedly connected, the lower lid 6 includes a first cylinder 61, a second cylinder 621, a third cylinder 62 and a fourth cylinder 63 which are coaxially arranged and sequentially reduced in diameter, a mounting hole 610 is arranged in a side wall of the first cylinder 61 to mount the driving part; a first stepped surface 612 is formed between the first cylinder 61 and the second cylinder 621, and a lower connecting columns 611 configured to be connected with the upper lid 2 are uniformly distributed on the first stepped surface 612 in a circumferential direction; a second stepped surface 622 configured to axially limit the screw is formed between the second cylinder 621 and the third cylinder 62; a side wall of the second cylinder 621 is provided with an external thread and forms the connecting portion 621a configured to be connected with the container; the sliding plug cavity 620 is formed in the third cylinder 62, sliding grooves 624 configured to be connected with the slider nut to achieve its sliding fit are uniformly distributed at an upper end of the sliding plug cavity 620 in the circumferential direction, and the first gas outlet 623 is formed at a bottom surface of the sliding plug cavity; a gas nozzle mounting chamber 630 with a lower end open is formed in the fourth cylinder 63, the gas nozzle 71 is fixed in the gas nozzle mounting chamber 630, the ejecting pin at the gas output end of the gas nozzle 71 extends into the sliding plug cavity, a side wall of the fourth cylinder is provided with an external thread and forms a second connecting portion configured to mount a gas bottle cover 9, and a gas bottle mounting chamber 900 configured to place the gas bottle 8 is formed in the gas bottle cover 9; and a pressure meter 21 is arranged on the upper lid 2.

Further, at least two bayonets 631 are uniformly distributed at a side wall of the gas nozzle mounting chamber 630 in a circumferential direction, a gas nozzle plug 73 is fixed in the gas nozzle mounting chamber through a buckle 732, the gas nozzle plug 73 is provided with a hole 730 allowing a head of the gas bottle 8 to pass through and forms a gas bottle connecting port, and a sealing ring 72 is arranged between the hole and the gas nozzle 71.

Further, a rotation angle of the driving part is less than 250 degrees, and a transmission ratio of the driving part to the driven part is 1/3 to 1/1.

Meanwhile, the present disclosure further provides a container for a gas-containing beverage or wine, which includes the above lid assembly.

Beneficial Effects

The lid assembly for adjusting internal pressure of the present disclosure is compact in structure, convenient to adjust, labor-saving, high in control precision and good in using effect. The lid assembly adopts a split type structure, lowers the production difficulty and the production cost is low, being easy for assembling. The shifter lever is arranged to save labor, and convenient and accurate to control angle. Due to bevel gear connection, the driving part is enabled to be located at the side wall of the lid assembly, being convenient and labor-saving for using and operation, transmission is stable and efficiency is high; the screw is hollow and forms the gas channel, the plunger portion and the plunger hole are arranged, so that the gas channel can stretch out and draw back, the structure is ingenious and compact, so that the pressure meter can measure and display the internal pressure timely, which is convenient to visually know the internal pressure and adjust according to requirements; and the screw achieves positioning installation through the supporting portion and the annular protrusion, enjoying high precision and large bearing force, being stable and reliable for operation. The container for containing a gas-containing drink of the present disclosure can maintain a gas (carbon dioxide) content in the drink, improve the drinking taste, and can be adjusted according to requirements to produce different tastes, being adaptable to different users with good experience.

### BRIEF DESCRIPTION OF FIGURES

FIG. 1 is a schematic structural diagram of a container of the present disclosure;

FIG. 2 is a schematic diagram showing the installation of a lid assembly for adjusting internal pressure on the container;

FIG. 3 is a schematic exploded diagram of the container of the present disclosure;

FIG. 4 is a schematic exploded structural diagram of the lid assembly for adjusting internal pressure of the present disclosure;

FIG. 5 is a cross-sectional view of the container of the present disclosure;

FIG. 6 is a cross-sectional view of the container of the present disclosure from another angle;

FIG. 7 is a schematic structural diagram of the lid assembly for adjusting internal pressure of the present disclosure;

FIG. 8 is a cross-sectional view of the lid assembly for adjusting internal pressure of the present disclosure;

FIG. 9 is a partial cross-sectional view of the lid assembly for adjusting internal pressure of the present disclosure;

FIG. 10 is a schematic structural diagram of an upper lid of the lid assembly for adjusting internal pressure of the present disclosure;

FIG. 11 is a schematic structural diagram of the upper lid of the lid assembly for adjusting internal pressure of the present disclosure from another angle;

FIG. 12 is a cross-sectional view of the upper lid of the lid assembly for adjusting internal pressure of the present disclosure;

FIG. 13 is a schematic structural diagram of a lower lid of the lid assembly for adjusting internal pressure of the present disclosure;

FIG. 14 is a schematic structural diagram of the lower lid of the lid assembly for adjusting internal pressure of the present disclosure from another angle;

FIG. 15 is a cross-sectional view of the lower lid of the lid assembly for adjusting internal pressure of the present disclosure;

FIG. 16 is a schematic structural diagram of a screw of the lid assembly for adjusting internal pressure of the present disclosure;

FIG. 17 is a schematic structural diagram of the screw of the lid assembly for adjusting internal pressure of the present disclosure from another angle;

FIG. 18 is a cross-sectional view of the screw of the lid assembly for adjusting internal pressure of the present disclosure;

FIG. 19 is a cross-sectional view of a sliding plug body of the lid assembly for adjusting internal pressure of the present disclosure;

FIG. 20 is a schematic structural diagram of a driven bevel gear of the lid assembly for adjusting internal pressure of the present disclosure;

FIG. 21 is a schematic structural diagram of a driving bevel gear of the lid assembly for adjusting internal pressure of the present disclosure;

FIG. 22 is a schematic structural diagram of a slider nut of the lid assembly for adjusting internal pressure of the present disclosure;

FIG. 23 is a schematic structural diagram of a gas nozzle plug of the lid assembly for adjusting internal pressure of the present disclosure; and

FIG. 24 is a schematic structural diagram of a gas bottle cover of the lid assembly for adjusting internal pressure of the present disclosure.

### DETAILED DESCRIPTION

Embodiments of the present disclosure are introduced in detail with reference to the accompanying drawings.

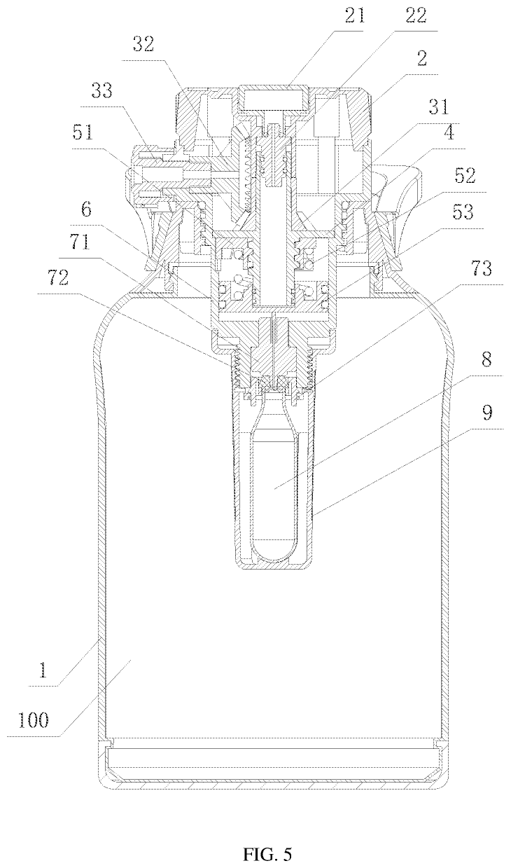

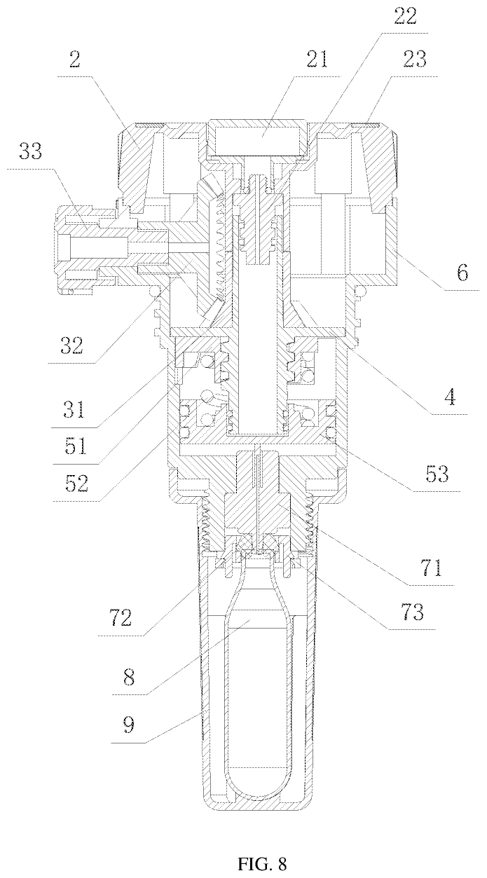

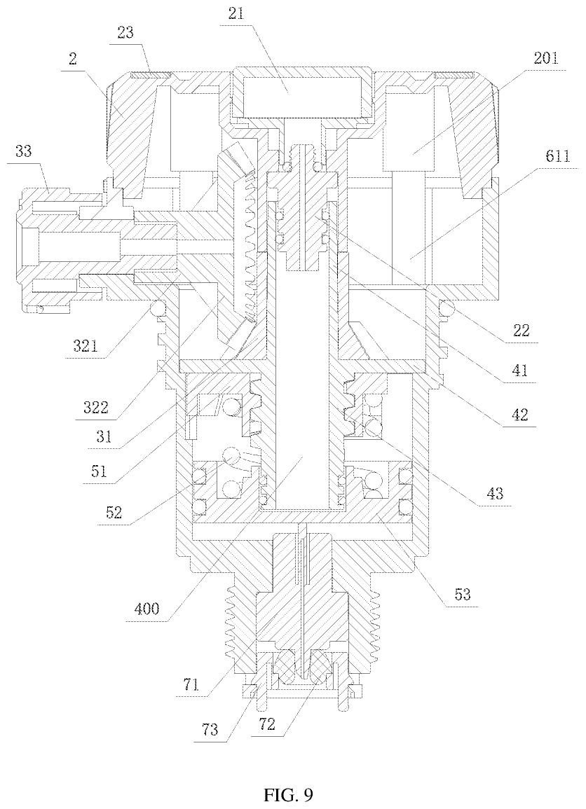

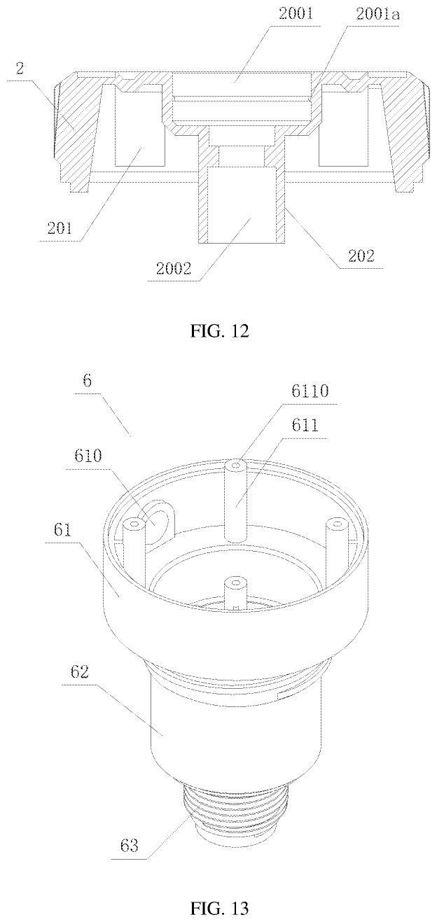

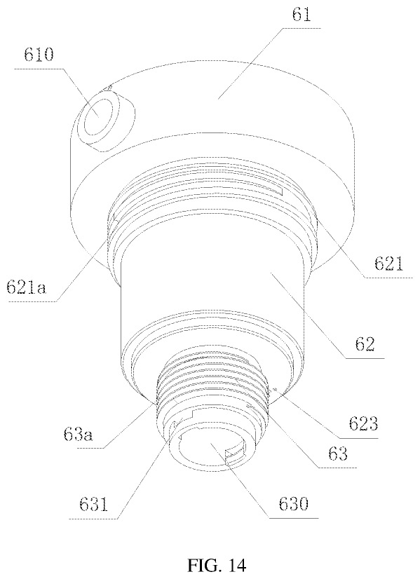

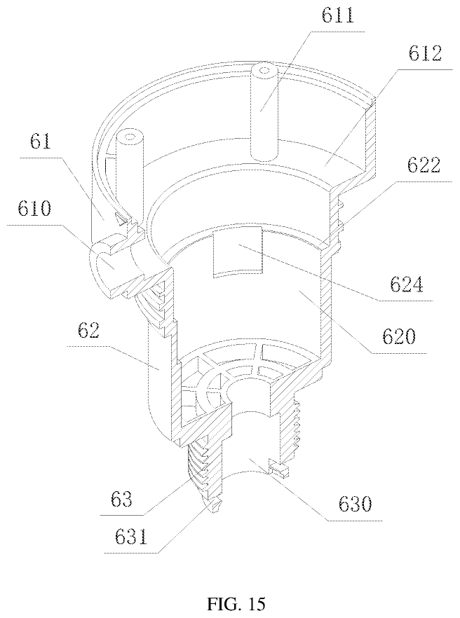

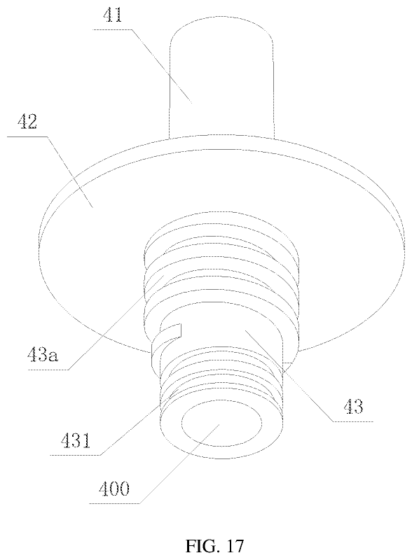

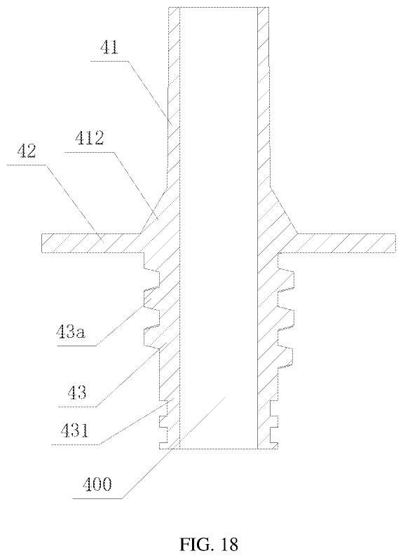

Referring to FIG. 5 and FIGS. 8-24, the present disclosure provides a lid assembly for adjusting internal pressure, which includes a lid main body. The lid main body serves as a mounting carrier for mounting other components. As a shell, inside of the lid main body serving is arranged with functional components, and the functional components mainly include a gas nozzle 71, a sliding plug cavity, a slider nut 51, an elastic component 52 and an adjusting assembly.

The gas nozzle 71 is configured to be connected with a gas bottle 8, the gas bottle 8 is filled with CO₂ gas, and the gas nozzle is configured to full carbonated drinks and beer in a container with the CO₂ gas in the gas bottle so as to improve the taste of the drinks or beer. The gas nozzle 71 has an input end and an output end as a valve body. Thereof, the input end is connected with a gas output end of the gas bottle, and the output end has a gas outlet and an ejecting pin. A gas discharge amount of the gas bottle is controlled by adjusting a degree of elasticity of the ejecting pin.

The sliding plug cavity is arranged at the gas output end of the gas nozzle 71, the ejecting pin extends into the sliding plug cavity, an axis direction of the sliding plug cavity is parallel to an axis direction of the ejecting pin of the gas nozzle, and a sliding plug body 53 is arranged to the sliding plug cavity in a sliding fit mode. A sliding direction of the sliding plug body 53 is parallel to the axis (length) direction of the ejecting pin, that is, when the sliding plug body moves, the sliding plug body can move in a direction close to or away from the ejecting pin (gas nozzle), and a lower end of the sliding plug body 53 is in contact with an end portion of the ejecting pin. A sealed first chamber is formed between a lower end surface of the sliding plug body 53 and the gas output end of the gas nozzle 71, a first gas outlet 623 is formed in a side wall of the first chamber, and the first gas outlet 623 is configured to communicate the first chamber with a material (liquid) storage tank chamber of the container, so that gas discharged from the gas bottle 8 enters into the material (liquid) storage tank chamber of the container after passing through the first chamber, and enters into the drinks or beer in the material (liquid) storage tank chamber.

The slider nut 51 is arranged in the lid main body in a sliding fit mode, its sliding direction is parallel to a moving direction of the sliding plug body 53, and the slider nut 51 is located at an upper end of the sliding plug body 53, so that the slider nut 51, the sliding plug body 53 and the gas nozzle 71 are located on the same straight line, and the sliding plug body 53 is located between the slider nut 51 and the gas nozzle 71.

The elastic component 52 is arranged between the slider nut 51 and the sliding plug body 53, and makes the slider nut and the sliding plug body trends to move in opposite directions. In this example, the elastic component 52 is a compression spring. When the slider nut 51 is fixed, the elastic component 52 enables the sliding plug body 53 to trends to move to be close to the gas nozzle (ejecting pin).

The adjustment assembly includes a driving part and a driven part that are meshed and connected with each other. The driving part and the driven part can achieve linkage, that is, an action of the driving part can drive the driven part to act. A head of the driving part, as an input end, extends to outside of the lid main body. The driven part is in threaded connection with the slider nut 51, and can drive the slider nut to slide in the axis direction of the sliding plug body 53.

The driving part is adjusted according to requirements. The driving part drives the driven part to act. The driven part drives the slider nut 51 to be close to or away from the gas nozzle 71. An elastic force generated by the elastic component makes the sliding plug body act. At the same time, when the sliding plug body is in contact with the ejecting pin, the gas in the gas bottle enters into the first chamber, and the gas in the first chamber enters into the container at the same time, so that gas pressure in the first chamber is the same as that of the container. At the same time, the (first chamber) gas pressure makes the sliding plug body move in a direction opposite to the gas nozzle, and finally the gas pressure and the elastic force generated by the elastic component are balanced.

A connecting portion is arranged on the side wall of the lid main body and is configured to realize connection with the container.

For convenient operation, in this example, the driving part and the driven part are connected through conical teeth. Thus, an included angle is formed between an axis of the driving part and an axis of the driven part, preferably, the included angle between the two axes is 90 degrees. The driving part includes a driving bevel gear 32 and a shifter lever 33, the driving bevel gear 32 is rotatably mounted on a side wall of the lid main body, and the shifter lever 33 is located outside the lid main body and rigidly connected with the driving bevel gear 32. The driving bevel gear is driven to rotate through rotation of the shifter lever 33, the shifter lever is in manual lifting, and an identification for displaying a rotation angle of the shifter lever is arranged on the side wall of the lid main body. The driven part includes a screw 4 and a driven bevel gear 31. The screw 4 is rotatably mounted inside the lid main body. A rotation axis of the screw 4 vertically intersects with a rotation axis of the driving bevel gear 32. A side wall of the screw 4 is provided with a thread 43a configured to be connected with the slider nut 51. The slider nut 51 is driven to slide axially through rotation of the screw 4. The driven bevel gear 31 is fixed to the screw 4, and the driven bevel gear is meshed with the driving bevel gear, as a power input end of the screw.

In order to visually know about an internal pressure condition conveniently, a pressure meter 21 is arranged on the lid main body. The pressure meter 21 communicates with the first chamber through a gas flow channel. Specifically, an end portion of the screw 4 extends downwards to form a plunger portion 431. A central hole is formed in an end portion of the plunger portion 431. The central hole upwards penetrates to outside of the screw, and forms the gas flow channel 400. The pressure meter 21 is arranged on a top of the central hole (gas flow channel). A plunger hole 531 is formed in a top center of the sliding plug body 53, allowing the plunger portion 431 to be inserted in through a sliding fit mode. A sealing part is arranged between the plunger portion 431 and the plunger hole 531 for sealing. A first gas hole 530 is formed in the bottom surface of the plunger hole 531, for the communication of the gas flow channel with the first chamber.

A structure of each component is described in detail below in combination with the accompanying drawings.

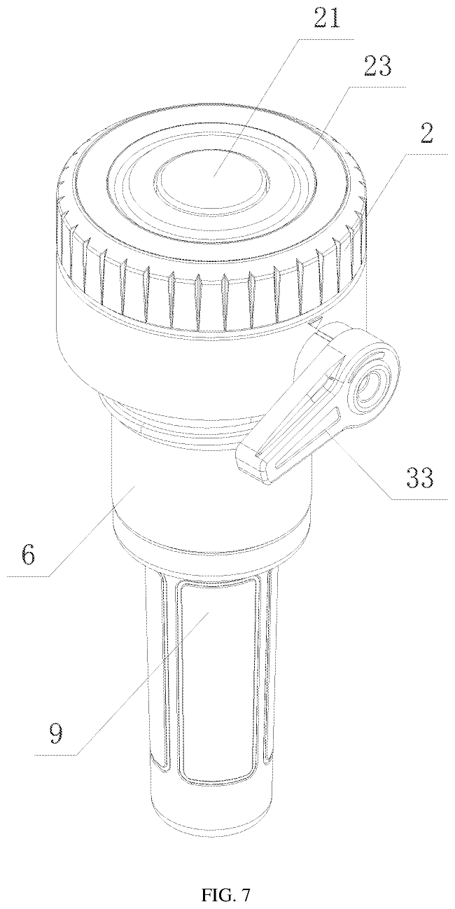

In FIGS. 7-15, the lid main body includes an upper lid 2 and a lower lid 6 which are fixedly connected. The lower lid 6 includes a first cylinder 61, a second cylinder 621, a third cylinder 62 and a fourth cylinder 63 which are coaxially arranged and sequentially reduced in diameter. A mounting hole 610 is formed in a side wall of the first cylinder 61 to mount the driving part. In order to improve stability of installation and transmission of the driving part, an edge of the mounting hole 610 extends outwards or inwards in an axial direction (in an axis direction of the mounting hole) to form a driving part mounting portion. The driving part mounting portion is cylindrical as a whole, and an axis of the driving part mounting portion vertically intersects with an axis of the lower lid. A first stepped surface 612 is formed between the first cylinder 61 and the second cylinder 621. At least two lower connecting columns 611 are uniformly distributed on the first stepped surface 612 in a circumferential direction, to be connected with the upper lid 2. In this example, four lower connecting columns 611 are uniformly distributed on the first stepped surface in the circumferential direction. A cross section of each lower connecting column 611 is circular. Screw holes 6110 are formed in top surfaces of the lower connecting columns. The lower connecting columns 611 are configured for positioning and fixing. A second stepped surface 622 is formed between the second cylinder 621 and the third cylinder 62, and the second stepped surface 622 is configured to axially limit the screw. In order to reduce a contact area and lower friction, a radial (in a radius direction) width of the second stepped surface is 1 mm to 3 mm. A side wall of the second cylinder 621 is provided with an external thread and forms the connecting portion 621a, and the connecting portion is configured to be connected with a bottle opening (screw opening) in the container. The sliding plug cavity 620 is formed in the third cylinder 62, and a cross section of the sliding plug cavity 620 is circular. At least two sliding grooves 624 are uniformly distributed in an upper end of the sliding plug cavity 620 in the circumferential direction. In this example, three sliding grooves 624 are formed, a length direction of the sliding groove 624 is parallel to an axis of the sliding plug cavity 620, and the sliding groove 624 upwards penetrates to the second stepped surface 622 in the axial direction. The sliding groove 624 is configured to mount the slider nut 51 so that the slider nut slides on the upper end of the sliding plug cavity in an axial direction. The slider nut 51 can slide in the axis direction of the sliding plug cavity, and cannot rotate in radial direction. The first gas outlet 623 is formed at the bottom surface of the sliding plug cavity (the stepped surface between the third cylinder and the fourth cylinder), to communicate the first chamber with the container. A gas nozzle mounting chamber 630 with a lower end open is formed in the fourth cylinder 63. The gas nozzle mounting chamber 630 is in a shape of a stepped hole with an upper end (the side close to the sliding plug cavity) small and a lower end large. The gas nozzle 71 (valve) is fixed in the gas nozzle mounting chamber 630. The ejecting pin at the gas output end of the gas nozzle 71 extends into the sliding plug cavity. A side wall of the fourth cylinder is provided with an external thread and forms a second connecting portion 63a configured to mount a gas bottle cover 9. At least two bayonets 631 configured to mount a gas nozzle plug are uniformly distributed in a side wall of the gas nozzle mounting chamber 630 in the circumferential direction.

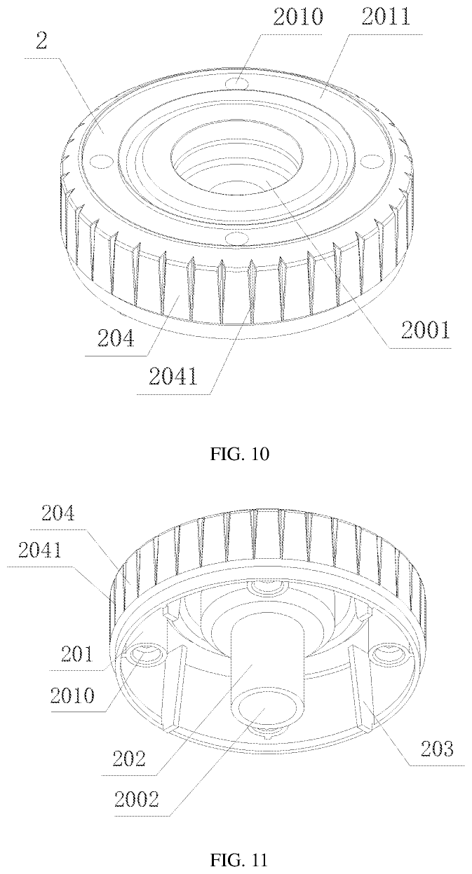

Referring to FIGS. 10-12, the upper lid 2 includes a lid body which is circular. An edge of the lid body is bent downwards by 90 degrees to form a tightening portion 204 which is cylindrical as a whole. Anti-slip grooves 2041 are uniformly distributed at an outer wall of the tightening portion 204 in the circumferential direction. A pressure meter mounting hole 2001 configured to mount the pressure meter is formed at a top surface of the lid body. An annular protrusion 2001a is formed in a side wall of the pressure meter mounting hole 2001. The annular protrusion is configured to contact with an outer wall of the pressure meter and fixing the pressure meter. A hole configured to be connected with the gas channel is formed at a bottom surface of the pressure meter mounting hole 2001. An edge of the hole extends downwards and forms a casing pipe 202. A stepped hole with an upper end small and a lower end large is provided and a mounting hole 2002 is formed in the casing pipe 202. A brass mouthpiece 22 of the pressure meter is mounted in the mounting hole. Meanwhile, the mounting hole 2002 serves as a supporting portion of the screw (supporting portion 41). An end portion of a lower end of the casing pipe 202 makes contact with a top of the driven part (driven bevel gear sleeve), to axially limit the driven part. Upper connecting columns 201 corresponding to the lower connecting columns are arranged on a lower end surface of the lid body. Inserting holes 2001 allowing the lower connecting columns to be inserted in are formed at bottom surfaces of the upper connecting columns. Meanwhile, central holes 2010 allowing screws to pass through to be connected with the lower connecting columns are formed at the upper connecting columns. In order to improve overall compactness and aesthetics, an annular groove 2011 is formed in a top surface of the lid body, and the central holes are located at a bottom surface of the annular groove. Thus, after the screws are installed, top surfaces of the screws are flush with or lower than the bottom surface of the annular groove. An annular shielding ring 23 is fixed in the annular groove 2011 through a binder to shield the screws, and meanwhile, an identification can be arranged on the shielding ring. In order to fast assembling, reinforcing ribs 203 are arranged between the lid body and an inner wall of the tightening portion. The reinforcing ribs are plate-shaped, uniformly distributed in the circumferential direction, and downwards extend to an outside of the upper lid by 1-2 mm to form a positioning portion. A chamfer is arranged at an end portion of an output end of the reinforcing rib, for rapidly positioning with the first cylinder on the lower lid and enhancing Assembling accuracy and efficiency. The structure is not only convenient to assemble, but also improve structural strength of the upper lid.

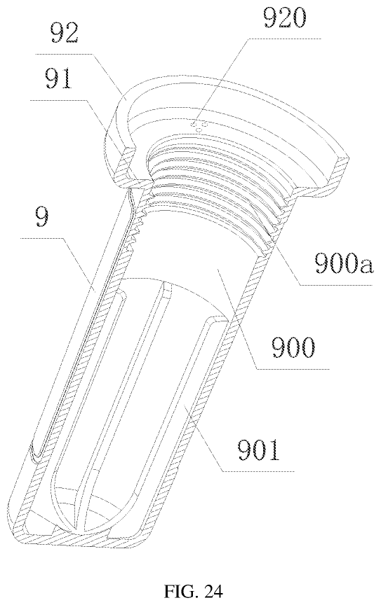

Referring to FIG. 24, the gas bottle cover 9 is configured to place the gas bottle 8. A gas bottle mounting chamber 900 for placing the gas bottle 8 is formed in the gas bottle cover. The gas bottle cover is of a cylindrical structure with an open upper end and a sealed lower end. An upper end of the gas bottle cover is bent radially outwards by 90 degrees to form a connecting surface 91. The connecting surface is provided with a gas hole 920. An edge of the first connecting surface 91 is bent upwards by 90 degrees and forms a shielding part 92 having the same diameter as the fourth cylinder. An internal thread 900a is arranged at the upper end of the gas bottle mounting chamber, and is configured to be connected with the second connecting portion on the lower lid. At least three supporting protrusions 901 are uniformly distributed at an inner wall of the gas bottle mounting chamber in the circumferential direction. Each of the supporting protrusions is flake-shaped, length direction thereof is parallel to an axis direction of the gas bottle cover, the supporting protrusion is configured to make contact with an outer wall of the gas bottle to achieve precise positioning and mounting. A lower end of the supporting protrusion 901 extends in the axis direction and forms an arc-shaped supporting portion to support the gas bottle with a semi-spherical bottom surface of the gas bottle.

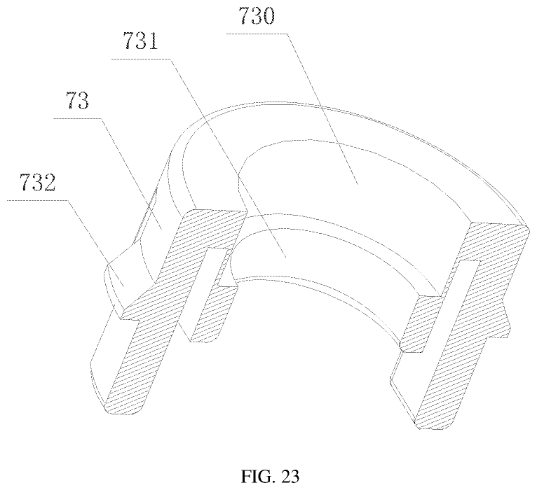

The gas nozzle plug 73 is installed at a lower end of the gas nozzle mounting chamber. Referring to FIG. 23, the gas nozzle plug 73 is cylindrical as a whole. Buckles 732 corresponding to the bayonets 631 are uniformly distributed at an outer wall of the gas nozzle plug in the circumferential direction, and the buckle is provided with an inclined guide plane. The hole 730 penetrates through two ends of the gas nozzle plug and a gas bottle connecting port (inserting port) allowing the head of the pressure bottle 8 to pass through is formed. Meanwhile, the annular protrusion is arranged in the hole, and a sealing ring check portion 731 is formed. A sealing ring is arranged between the sealing ring check portion and the gas nozzle, to realize the sealing performance of connection between the pressure bottle and the gas nozzle is achieved.

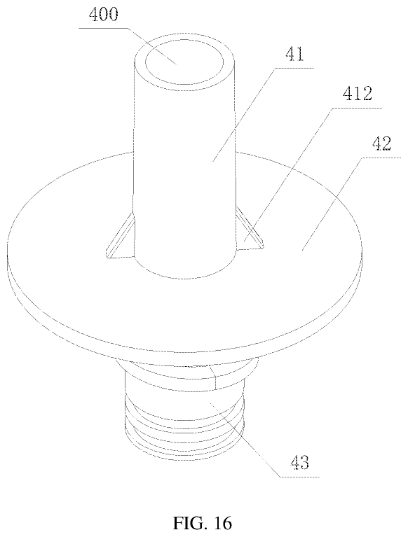

Referring to FIGS. 16-18, the screw 4 includes the supporting portion 41, a screw portion 43 and the plunger portion 431 which are sequentially connected from top to bottom and coaxially arranged, and cross sections of the supporting portion, the screw portion and the plunger portion are all circular. A lower end side wall of the supporting portion 41 extends outwards radially to form an annular protrusion 42. The annular protrusion 42 is configured to make contact with the second stepped surface on the lower lid to axially limit the screw. The driven bevel gear is arranged on a root of the supporting portion 41 (a joint of the supporting portion and the annular protrusion). During assembling, the supporting portion 41 is arranged in the casing pipe 202 of the upper lid in a sleeved mode. In order to reduce production cost and facilitate assembling, in this example, the screw and the driven bevel gear are designed in a split mode, and the driven bevel gear is mounted on the supporting portion 41 through a key. Specifically, the supporting portion 41 is sleeved with a sleeve 311 through a key 412. A sleeve hole 310 is formed in the sleeve and configured to sleeve the supporting portion. Meanwhile, a key groove 3101 is formed in the sleeve hole. A lower end of the sleeve 311 makes contact with an upper surface of the annular protrusion. A conical surface is provided on a lower end side wall of the sleeve 311, and teeth 31a are arranged on the conical surface to form the driven bevel gear. An end portion of the casing pipe 202 makes contact with an end portion of the sleeve 311 to realize axial limiting. The screw portion is located at a lower end of the annular protrusion, and a thread 43a for transmission is arranged outside the screw portion, and is configured to be connected with the slider nut and drive the slider nut to slide. The plunger portion 431 is cylindrical as a whole, and is sleeved in the plunger hole of the sliding plug body to achieve relative movement. One or more annular grooves are formed in a side wall of the plunger portion, and an O-shaped sealing ring is arranged in the annular groove to realize sealed connection with the plunger hole. An end surface of the plunger portion is provided with a central hole, and the central hole extends upward to an outer side of the supporting portion and forms the gas flow channel 400.

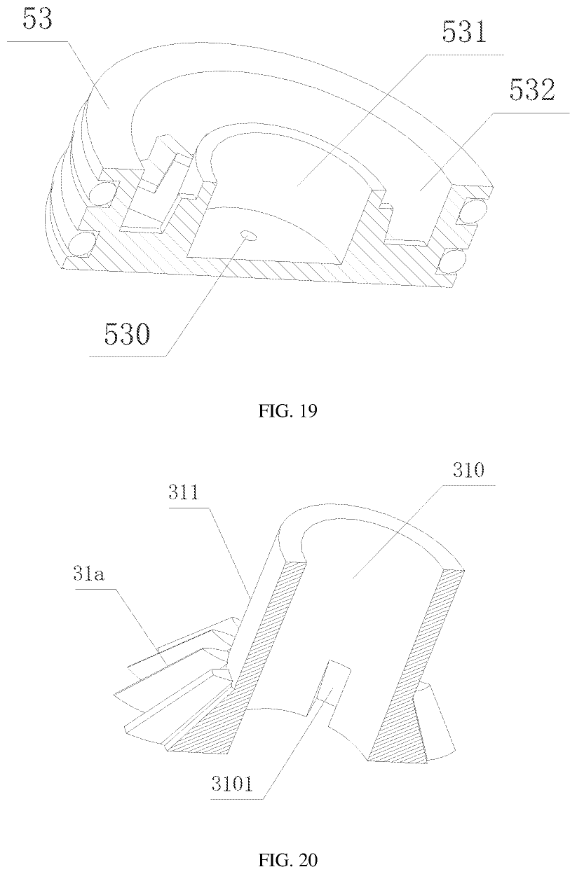

Referring to FIG. 19, the sliding plug body 53 includes a sliding plug body which is cylindrical as a whole. One or more annular grooves for installing the O-shaped sealing rings are formed at the side wall of the sliding plug body, a recessed hole with a circular cross-section is provided in a center of an upper end surface of the sliding plug body and the plunger hole 531 is formed for the insertion of the plunger portion of the screw. The first gas hole 530 is formed in the bottom surface of the plunger hole and configured to communicate the first chamber with the gas flow channel. At the same time, an annular mounting groove 532 coaxial with the plunger hole is formed at an upper surface of the sliding plug body and configured to mount the elastic component (spring).

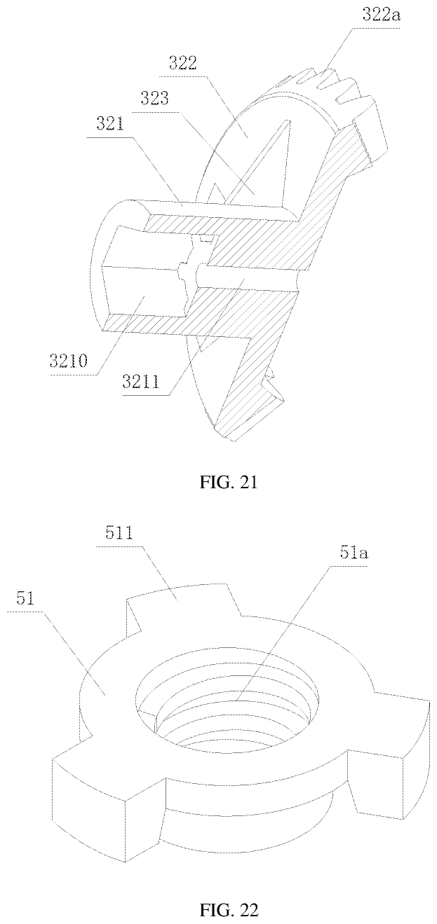

Referring to FIG. 21, the driving bevel gear includes a cylindrical body 321 as a rotating shaft. An end portion of the cylindrical body 321 extends outwards radially and forms a circular gear disk 322, a conical surface is arranged on an edge of the gear disk, and teeth are arranged on the conical surface and form conical teeth 322a. A head end surface of the cylindrical body is provided with a connecting hole 3210 with a cross section of a regular polygon shape. The connecting hole is configured to be connected with the shifter lever. A screw hole 3211 is formed at a bottom surface of the connecting hole. In order to improve structural strength, reinforcing ribs 323 are arranged between the gear disk and an outer wall of the cylindrical body. In this example, a rotation angle of the driving part is less than 250 degrees, and a transmission ratio of the driving part to the driven part is 1/3 to 1/1, preferably 1/2.

Referring to FIG. 22, the slider nut 51 is cylindrical as a whole, and a screw hole 51a configured to be connected with the screw penetrates through both ends of the slider nut. Limiting portions 511 protruding outwards are uniformly distributed on a side wall of the slider nut in the circumferential direction. The limiting portion is arranged in the sliding groove in the sliding plug cavity in a sliding fit mode, to achieve a circumferential sliding fit of the slider nut, and cannot achieve radial rotation.

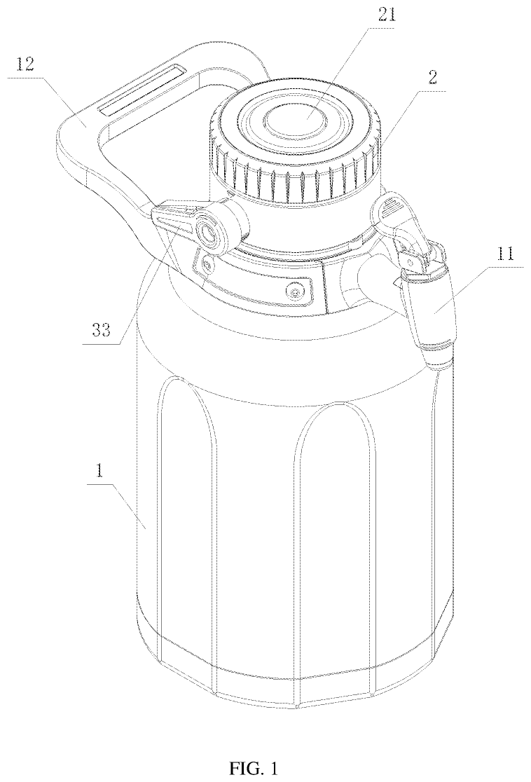

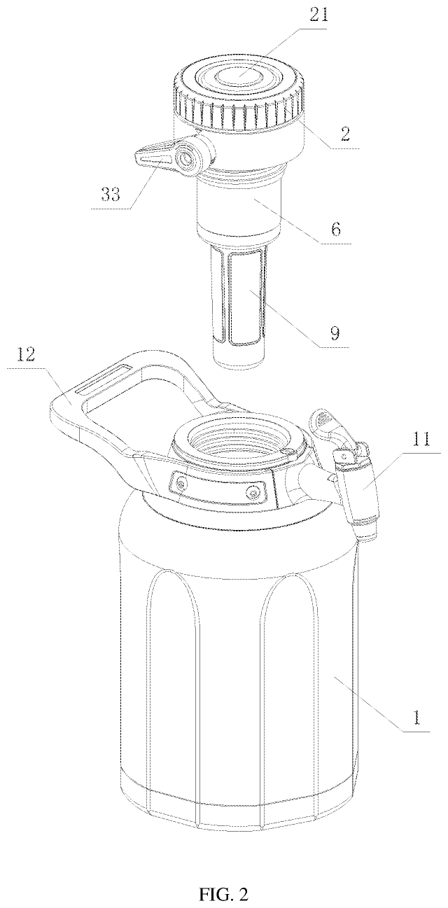

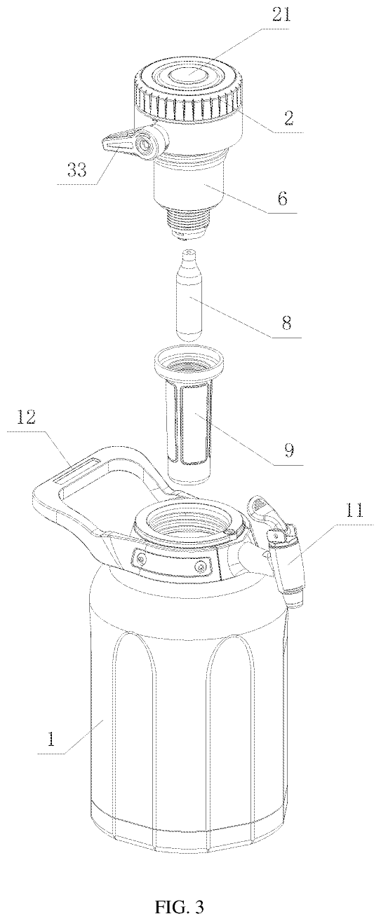

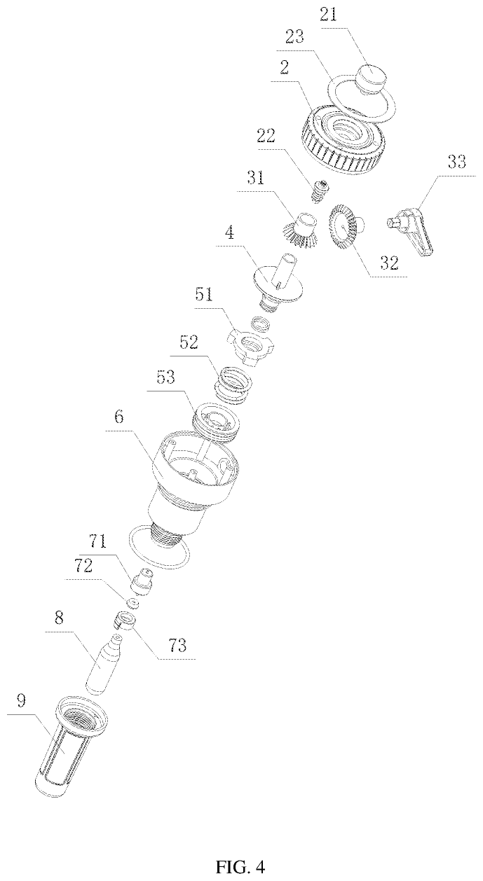

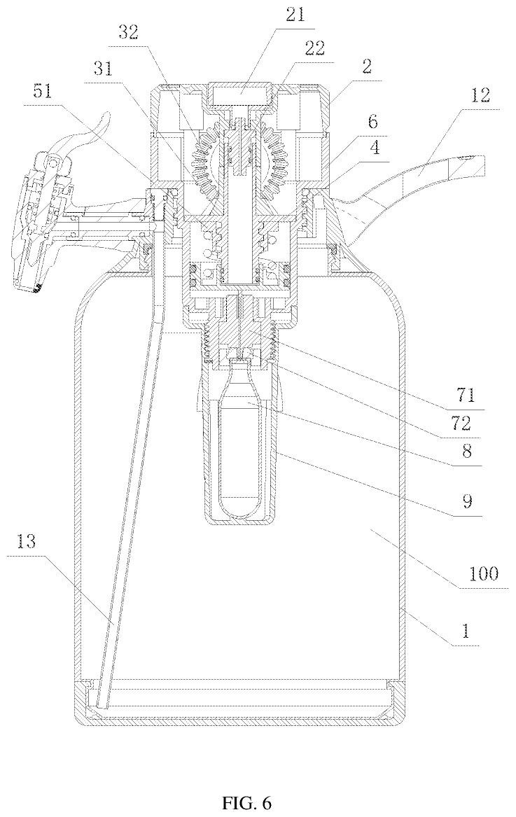

Referring to FIGS. 1 to 6, the present disclosure further provides a container for a gas-containing beverage or wine, including a container body 1. An upper end of the container body 1 is retracted and opened, and a containing chamber 100 for containing the beverage or beer is formed in the container body. A straw 13 is arranged in the containing chamber. One end of the straw extends to a bottom of the containing chamber, and the other end of the straw communicates with a faucet. When there is a certain pressure in the containing chamber, liquid in the containing chamber can be sucked out from the straw. A handler 12 and the faucet 11 are arranged at the upper end of the container body, the upper open end of the containing chamber is provided with an internal thread and forms a screw port, and the lid assembly is mounted at the screw port.

In use, the container 1 is filled with the gas-containing drink (such as carbonated drinks or beer), the gas bottle 8 is mounted in the gas bottle cover 9, the gas bottle cover is connected to the lower lid 6 in a threaded mode, and then the lid assembly is mounted to the screw hole of the container and tightened. The shifter lever 33 is rotated as required, the driving bevel gear rigidly connected with the shifter lever is driven, the driving bevel gear rotates to drive the driven bevel gear meshed with the driving bevel gear, and the driven bevel gear rotates to drive the screw to rotate. The screw rotates to drive the slider nut in threaded connection with the screw to move downwards. The sliding plug body is pushed to move downwards under an acting force of the spring, and the ejecting pin on the gas nozzle is pushed to move downwards, and compressed gas (commonly being CO₂) in the gas bottle is enabled to enter into the first chamber, high pressure is formed in the first chamber, the high pressure generates thrust and pushes the sliding plug body to move upwards, the elastic component (spring) located above the sliding plug body bears the force, and finally, balance is achieved between the gas pressure and the spring force. The gas is discharged from the first gas outlet 623 in the side wall of the first chamber and enters into the container chamber, and meanwhile enters into the gas flow channel 400 through the first gas hole so that pressure of the gas flow channel, the first chamber and the container chamber achieves balance (the same pressure). The pressure meter on the lid communicates with the gas flow channel and measures a pressure value. Internal pressure of the container is higher than an atmospheric pressure, the gas (CO₂) fully enters into the beverage or beer, and then the taste of the beverage or beer is improved; and when drinking, the faucet is opened, the beverage or beer is discharged from the faucet through the straw under the action of the pressure.

The gas discharge amount of the gas bottle depends on an ejection length of the ejecting pin. When the ejection length is large, the gas discharge amount is small, and when the ejection length is small, the gas discharge amount is large, which is controlled by the sliding plug body. In this example, a movement journey of the sliding plug body depends on a rotation angle of the shifter lever. The larger the rotation angle, the longer the movement distance of the sliding plug body (downward), and the larger the gas discharge amount; and the smaller the rotation angle, the shorter the movement distance of the sliding plug body (downward), and the smaller the gas discharge amount. In this example, the rotation angle of the shifter lever (driving bevel gear) is 240 degrees, the movement journey of the slider nut is 3 mm to 4 mm, the movement journey of the sliding plug body is 0.4 mm to 0.8 mm, the running distance of the sliding plug body is adjusted by the rotation angle of the shifter lever to control the gas discharge amount, and then have different tastes.

The lid assembly for adjusting internal pressure is compact in structure, convenient to adjust, labor-saving, high in control precision and good in using effect. The lid assembly adopts a split type structure, lowers the production difficulty and the production cost, and convenient and accurate for assembling. The shifter lever 33 is arranged to save labor, and convenient and accurate for angle control. Due to bevel gear connection, the driving part is enabled to be located on the side wall of the lid assembly, being convenient and labor-saving for using and operation; the screw is hollow and forms the gas channel, the plunger portion and the plunger hole are arranged, so that the gas channel can stretch out and draw back, the structure is ingenious and compact, so that the pressure meter can measure and display the internal pressure timely, which is convenient to visually known the internal pressure and adjust according to requirements; and the screw achieves positioning installation through the supporting portion and the annular protrusion, enjoying high precision and large bearing force , being stable and reliable for operation. The container for containing the gas-containing drink of the present disclosure can maintain a gas (carbon dioxide) content in the drink, improve the drinking taste, and can be adjusted according to requirements to produce different tastes, being adaptable to different users with good experience.

What described above is only the preferred embodiments of the present disclosure. It should be pointed out that for those of ordinary skill in the art, without departing from the technical principles of the present disclosure, more improvements and modifications can also be made, and these improvements and modifications should also be regarded as the protection scope of the present disclosure.

What is claimed is:

1. A lid assembly for adjusting internal pressure, comprising:
a lid main body, as a mounting carrier for mounting other components, provided with:
a gas nozzle (71), configured to be connected with a gas bottle (8);
a sliding plug cavity, arranged at a gas output end of the gas nozzle (71), a sliding plug body (53) is arranged in the sliding plug cavity in a sliding fit mode, capable of being close to or away from the gas nozzle (71) and making contact with an ejecting pin on the gas nozzle (71) to control a gas output amount of the gas bottle (8), a sealed first chamber being formed between the sliding plug body (53) and the gas output end of the gas nozzle (71), and a side wall of the first chamber is opened with a first gas outlet (623) for communication with a container chamber;
a slider nut (51), arranged in the lid main body in a sliding fit mode, a sliding direction of the slider nut (51) being parallel to a sliding direction of the sliding plug body (53);
an elastic component (52), arranged between the slider nut (51) and the sliding plug body (53) and enabling the slider nut and the sliding plug body to trend to move in opposite directions;
an adjusting assembly, comprising a driving part and a driven part which are meshed and linked, a head of the driving part as an input end, extending to outside of the lid main body, and the driven part being in threaded connection with the slider nut (51) and configured to drive the slider nut to move; and
a connecting portion, configured to be connected to a container.

2. The lid assembly for adjusting internal pressure according to claim 1, wherein the driving part and the driven part are connected through conical teeth.

3. The lid assembly for adjusting internal pressure according to claim 1, wherein the lid main body is provided with a pressure meter (21), and the pressure meter (21) communicates with the first chamber through a gas flow channel.

4. The lid assembly for adjusting internal pressure according to claim 1, wherein the driving part comprises a driving bevel gear (32) rotatably mounted on a side wall of the lid main body and a shifter lever (33) located outside the lid main body and rigidly connected with the driving bevel gear; and the driven part comprises a screw (4) rotatably mounted inside the lid main body and a driven bevel gear (31) fixed on the screw (4) and meshed with the driving bevel gear (32), a rotation axis of the screw (4) vertically intersects with a rotation axis of the driving bevel gear (32), and a side wall of the screw (4) is provided with a thread (43a) configured to be connected with the slider nut (51) to drive the slider nut to move.

5. The lid assembly for adjusting internal pressure according to claim 4, wherein an end portion of the screw (4) extends downwards and forms a plunger portion (431), and an end portion of the plunger portion (431) is provided with a central hole penetrating upwards to an outer side of the screw and forms a gas flow channel (400); and a top center of the sliding plug body (53) is provided with a plunger hole (531) allowing the plunger portion (431) to be inserted in through a sliding fit mode, a sealing part is arranged between the plunger portion (431) and the plunger hole (531), and a bottom surface of the plunger hole (531) is provided with a first gas hole (530) configured to communicate the gas flow channel (400) with the first chamber.

6. The lid assembly for adjusting internal pressure according to claim 5, wherein the screw (4) comprises a supporting portion (41), a screw portion (43) and the plunger portion (431) which are sequentially connected from top to bottom and coaxially arranged, a lower end side wall of the supporting portion (41) extends outwards in a radial direction and forms an annular protrusion (42), an upper end of the sliding plug cavity is provided with a second stepped surface (622) configured to make contact with the annular protrusion to achieve axial limiting, a root of the supporting portion (41) is provided with a driven bevel gear, and the lid main body is provided with a casing pipe (202) allowing the supporting portion (41) to be inserted in.

7. The lid assembly for adjusting internal pressure according to claim 6, wherein the supporting portion (41) is sleeved with a sleeve (311) through a key (412), a lower end of the sleeve (311) makes contact with an upper surface of the annular protrusion, a conical surface is arranged on a lower end side wall of the sleeve (311), the conical surface is provided with teeth (31a) and forms the driven bevel gear, an end portion of the casing pipe (202) makes contact with an end portion of the sleeve (311) and axial limiting is achieved.

8. The lid assembly for adjusting internal pressure according to claim 4, wherein the lid main body comprises an upper lid (2) and a lower lid (6) which are fixedly connected, the lower lid (6) comprises a first cylinder (61), a second cylinder (621), a third cylinder (62) and a fourth cylinder (63) which are coaxially arranged and sequentially reduced in diameter, and a mounting hole (610) is formed in a side wall of the first cylinder (61) to mount the driving part; a first stepped surface (612) is formed between the first cylinder (61) and the second cylinder (621), and lower connecting columns (611) configured to be connected with the upper lid (2) are uniformly distributed on the first stepped surface (612) in a circumferential direction; a second stepped surface (622) configured to axially limit the screw is formed between the second cylinder (621) and the third cylinder (62); a side wall of the second cylinder (621) is provided with an external thread and forms the connecting portion (621a) configured to be connected with the container; the sliding plug cavity (620) is formed in the third cylinder (62), sliding grooves (624) configured to be connected with the slider nut to achieve its sliding fit are uniformly distributed in an upper end of the sliding plug cavity (620) in the circumferential direction, and the first gas outlet (623) is formed in a bottom surface of the sliding plug cavity; a gas nozzle mounting chamber (630) with a lower end open is formed in the fourth cylinder (63), the gas nozzle (71) is fixed on the gas nozzle mounting chamber (630), the ejecting pin at the gas output end of the gas nozzle (71) extends into the sliding plug cavity, a side wall of the fourth cylinder is provided with an external thread and forms a second connecting portion configured to mount a gas bottle cover (9), and a gas bottle mounting chamber (900) configured to place the gas bottle (8) is formed in the gas bottle cover (9); and a pressure meter (21) is arranged on the upper lid (2).

9. The lid assembly for adjusting internal pressure according to claim 8, wherein at least two bayonets (631) are uniformly distributed in a side wall of the gas nozzle mounting chamber (630) in a circumferential direction, a gas nozzle plug (73) is fixed on the gas nozzle mounting chamber through a buckle (732), the gas nozzle plug (73) is provided with a hole (730) allowing a head of the gas bottle (8) to pass through and forms a gas bottle connecting port, and a sealing ring (72) is arranged between the hole and the gas nozzle (71).

10. The lid assembly for adjusting internal pressure according to claim 1, wherein a rotation angle of the driving part is less than 250 degrees, and a transmission ratio of the driving part to the driven part is 1/3 to 1/1.

11. A container for a gas-containing beverage or wine, comprising the lid assembly according to claim 1.
